(19) United States
(12) Patent Application Publication
(10) Pub. No.: US 2019/0373930 A1
(43) Pub. Date: Dec. 12, 2019

(54) NATURAL FLAVOR BASE AND PROCESS FOR ITS PREPARATION

(71) Applicant: SOCIETE DES PRODUITS NESTLE S.A., Vevey (CH)

(72) Inventors: Helge Ulmer, Singen (DE); Josef Kerler, Bern (CH)

(21) Appl. No.: 16/485,323

(22) PCT Filed: Feb. 13, 2018
(86) PCT No.: PCT/EP2018/053548

§ 371 Date: Aug. 12, 2019

(30) Foreign Application Priority Data
Feb. 16, 2017 (EP) 17156404.0

(51) Int. Cl. A23L 27/21

(52) U.S. Cl. CPC A23L 27/215; A23V 2002/00

(57) ABSTRACT

The present invention relates to a process for preparing a natural flavor base and a flavor base obtainable by such process. A further aspect of the invention is a method for providing a natural herbaceous, a natural caramel and/or a natural hay flavor note to a food product.

The present invention relates to a process for preparing a natural flavor base and a flavor base obtainable by such process. A further aspect of the invention is a method for providing a natural herbaceous flavor note to a food product.

Additives such as purified amino acids, vitamins or flavor molecules are commonly used to enhance body and taste in flavour reactions and composition in food products. The problem with using these additives, however, is that they are not considered as being natural as they are typically obtained first by purification or chemical synthesis involving one or more non-natural processing steps such as elution from impurities with using chemical eluents, or chemical synthetic reactions.

Natural flavour standards in various countries, including Europe, determine flavours made of only natural components but prepared by performing chemical processes or adding further components as non-natural flavours. An example would be methods for preparing L-cysteine by two steps (fermentation and chemical reduction). For this reason, it is desirable to have flavoring components prepared using natural processes such as fermentation only and omitting any chemical production steps.

WO 2009/040150 discloses a natural shelf-stable taste enhancing savoury base produced by fermentation using a microorganism of the genus Corynebacterium, Brevibacterium or Bacillus. The savoury base comprises an amount between 10 and 80% by weight of naturally derived compounds such as glutamate, inosine monophosphate (IMP), and guanosine monophosphate (GMP); and further naturally derived compounds selected from the group consisting of organic acids, amino acids, peptides and aroma compounds; and a low fat content of the savoury base in the range of 0 to 15% by weight. The disclosed savory base improves the umami taste in food products. However, it does not provide a top-flavor note by itself.

EP0357812 describes a process for improving the flavour of protein products derived from microorganisms which comprises culturing the microorganism in the presence of a flavour enhancing additive, heat treating the resulting ferment, and then drying of same in the absence of a centrifugation. Examples of flavour enhancing additives added during the fermentation are animal by-products (beef extract, pork extract, or chicken extract) or fatty acids produced by adding a dairy product precursor and lipase. The additive is used 0.5-5 wt %. In this case, the objective is to produce protein-rich food stuff and not an intermediate ingredient rich in precursors that can be used in subsequent flavour reactions.

WO2015020292 relates to a method for preparing an inosine-5′-monophosphate (IMP) fermented broth or a glutamic acid fermented broth as a raw material for preparation of a natural flavour. The method comprises two fermentation steps, a first fungal fermentation step and a second bacterial fermentation step. The IMP fermented broth and glutamic acid fermented broth may be used as raw materials for preparing various natural flavours, for example, neutral flavours (WO2015012466), and flavours for beef (WO2015012464), chicken, pork, kokumi (WO2015012465) and the like. These flavours can be customized by using different raw materials, or slightly changing the medium composition, or controlling process conditions, including temperature, pressure and time, in the process of mixing the fermented broths, or a reaction or electrodialysis process. Having two fermentation steps as described would have the following consequences for an industrial production: (1) the final product is highly sensitive to the changes in raw material characteristics and quality; (2) the control of two fermentation steps involves highly specialized equipment and handling skills; and (3) the performance of the final product depends highly on the initial amount being freed during hydrolysis.

Often, yeast extract as a natural source of amino acids is added to food products, and/or used in thermal reaction flavor processes. An example is provided in U.S. Pat. No. 4,879,130. However, the use of yeast extract usually adds a typical yeasty note or off-flavor to such flavor bases and food products. This is usually not very liked by many consumers, particularly in Europe and the USA. In addition the use of yeast cells add complexity to the process steps to lyophilize the cells within at least one further process step.

Hence, there is still a persisting need in the art and the food industry to provide new processes for preparing savory flavor base compositions which provide flavour bases which are considered absolutely natural by consumers and which at the same time can also provide new and more complete and authentic flavour profiles and flavour top-notes.

### SUMMARY OF THE INVENTION

The object of the present invention is to improve the state of the art and to provide a new process for preparing a natural savoury flavour base which is considered all natural by consumers and which provides an improved and all natural flavour profile to food products. A further object of the present invention is a method for providing a natural and authentic herbaceous flavor note to a food or seasoning product.

The object of the present invention is achieved by the subject matter of the independent claims. The dependent claims further develop the idea of the present invention.

Accordingly, the present invention provides in a first aspect a process for preparing a natural flavor base composition comprising the steps of:
culturing a bacterial strain in a culture medium to produce and accumulate L-threonine in the culture medium to a concentration of at least 1.0 wt % of the culture medium;
optionally separating the bacterial strain from the culture medium after the culturing step;
optionally concentrating the culture medium after the culturing step;
adding a reducing sugar to the culture medium after the culturing step;
thermally reacting the culture medium after the addition of the reducing sugar at a temperature from 75-170° C. for at least 5 minutes;
optionally concentrating the medium after the thermal reaction step by evaporation or spray drying
   wherein the reducing sugar is added to the medium in an amount of 1:5 to 12:1 (w/w) ratio sugar:threonine.

In a second aspect, the invention relates to a natural flavor base obtainable by the process of the present invention.

A third aspect of the invention relates to the use of the present natural flavor base of the present invention for adding a caramel, a herbaceous and/or a hay flavored note to a food product.

A still further aspect of the invention is a method for providing a natural caramel, a natural herbaceous and/or a natural hay flavored flavor note to a food product comprising the step of adding the natural flavor base of the present invention into the recipe of a said food product.

The inventors found that a culture of a bacterial strain, such as for example a Corynebacterium glutamicum, which is cultivated either in such a way that it overproduces L-threonine or conditioned in such a way that it overproduces L-threonine, can be directly used in a thermal reaction process to generate a savory flavor base which is perceived by consumers as all natural and which has surprisingly even an improved herbaceous flavor profile in comparison to prior art savory flavor bases. For this new process, a bacterial culture can be taken as such, i.e. without separating the bacterial cells from the culture medium after the fermentation step, or alternatively, the bacterial cells can first be removed from the culture medium after fermentation by sedimentation, centrifugation and/or filtration. For ease of further processing, the culture medium can then be concentrated in order to remove a substantial amount of the water present in the cultured medium. Thus, for example a paste of concentrated cultured medium can be obtained having a residual moisture content of only ca. 5 to 40 wt %. A reducing sugar, for example glucose, can then be added to the concentrated cultured medium and the mixture further processed by thermally reacting the mix at a temperature above 75° C., preferably above 85° C. This thermally induced chemical reaction is also known under the term Maillard reaction. Optionally, the reaction end-product can then be further concentrated, e.g. into a paste, or dried into a powder.

The inventors have surprisingly found that when using this process, natural flavor base compositions can be generated which have a significantly improved herbaceous flavor note than prior art processes which make use of just regular non-conditioned bacterial fermentation media such as for example described in WO2009/040150, or by using isolated, purified L-threonine in Maillard reaction model systems. Evidence thereof is provided here below in the Examples section. Consequently, the present invention provides a new process which has the advantage of being absolute natural, i.e. without the use of and addition of isolated chemicals or molecules, of being relatively cheap and applicable industrially at a large scale, and which provides an even better herbaceous flavor profile to the resulting flavor base composition.

### BRIEF DESCRIPTION OF THE DRAWINGS

FIG. 1: Sensory evaluation of the samples 1-4, labelled 1 to 4 respectively. A stands for malty, B for caramel, C for herbaceous and D for hay.

### DETAILED DESCRIPTION OF THE INVENTION

The present invention relates to a process for preparing a natural flavor base composition comprising the steps of:
culturing a bacterial strain in a culture medium to produce and accumulate L-threonine in the culture medium to a concentration of at least 1.0 wt % of the culture medium;
optionally separating the bacterial strain from the culture medium after the culturing step;
optionally concentrating the culture medium after the culturing step;
adding a reducing sugar to the culture medium after the culturing step;
thermally reacting the culture medium after the addition of the reducing sugar at a temperature from 75-170° C. for at least 5 minutes;
optionally concentrating the medium after the thermal reaction step by evaporation or spray drying
   wherein the reducing sugar is added to the medium in an amount of 1:5 to 12:1 (w/w) ratio sugar:threonine.

The term “natural” of the present invention means “made by natural produce”, i.e. the flavor base composition is made by fermentation and heat treatment only. Therefore, “natural” also means that the flavor base composition does not comprise and is not made with an addition of artificial chemical compounds such as synthetically produced and/or chemically purified molecules. Examples of such undesired molecules are flavoring compounds, colorants, antimicrobial compounds, vitamins, amino acids, organic acids, alcohols, and esters.

The “culturing a bacterial strain” is by fermentation. Typically, such fermentations are submerged and conducted in closed or open fermentation reactors. The choice and composition of the culture medium depends on the choice of the bacterial strain selected for producing and accumulating L-threonine in said culture medium. Typically, the skilled person familiar with the fermentation processes of a selected bacterial strain knows and can readily compose a culture medium which is appropriate for the respective culturing process.

Preferably, the bacterial strain for the process of the present invention is belonging to a genus selected from Corynebacterium, Arthrobacter, Brevibacterium, Bacillus or Microbacterium.

In a preferred embodiment, the culturing of the bacterial strain produces and accumulates L-threonine to a concentration of at least 1.5 wt %, preferably to at least 2.0 wt %, preferably to at least 2.5 wt %, preferably to at least 3.0 wt %, preferably to at least 4.0 wt %, preferably to at least 5.0 wt %, preferably to at least 10.0 wt %, preferably to at least 20.0 wt %, preferably to at least 25.0 wt % of the culture medium. Concentrations of L-threonine would more preferably be in a range of 5 to 70 wt %, more preferably be in a range of 10 to 70 wt %, more preferably be in a range of 20 to 70 wt %, more preferably be in a range of 25 to 70 wt %, more preferably be in a range of 30 to 70 wt % of the culture medium.

In one embodiment, the process of the present invention further comprises a step of heat inactivation of the bacterial strain after the culturing step. This heat inactivation is done after termination of the fermentation process, i.e. at the end of the growth phase of the bacterial cells in the culture medium, and results in an inactivation of the viability of the bacterial cells, including an inactivation of enzymes which have been released or are still contained within the bacterial cells. Heat inactivation potentially prevents a degradation of the complex composition of the culture medium after the culturing step as to e.g. uncontrolled further growth and/or metabolism of the bacteria and/or uncontrolled further activity of certain enzymes.

In one further embodiment, the bacterial strains are separated from the culture medium after the culturing step, i.e. after the fermentation process. Separation of the bacterial strain from the culture medium can typically be obtained by sedimentation, centrifugation and/or filtration. An advantage of this embodiment may be that further handling of the culture medium in the process of the present invention is easier in an industrial setting. Furthermore, the risk of the bacterial strains to potentially degrade the quality of the achieved culture medium once the fermentation process has been terminated is reduced. In an embodiment of the invention the process does not include any thermal, enzymatic and/or acidic lyophilization step.

In a still further embodiment, the culture medium can be concentrated after the culturing step. This can be done with or without previous separation of the bacterial strain from the culture medium. Consequently, a concentrated culture medium according to this embodiment may or may not comprise bacterial cells. Preferably, concentrating the culture medium after the culturing step is by partial or total evaporation of water present in the culture medium. Preferably, the resulting concentrated culture medium is in the form of a paste. Such a paste may still have a water content of between 5-40 wt %, preferably of between 15-35 wt %. One of the advantages of this embodiment is that it allows conducting the thermal chemical reaction step together with the reducing sugar in a more concentrated form. Efficiency and yield of such a chemical reaction will be substantially increased.

In one embodiment of the present invention, the reducing sugar added to the culture medium after termination of the culturing step, is a 4, 5 or 6 carbon atoms comprising monosaccharide. Alternatively, a disaccharide reducing sugar can be used as well. Preferably, the reducing sugar is selected from the group consisting of glucose, xylose, ribose, rhamnose, fructose, maltose, lactose, arabinose or a combination thereof. The most preferred sugar is glucose.

In one embodiment of the present process, the reducing sugar is added to the medium in an amount of 1:5 to 12:1 (w/w) ratio sugar:threonine, preferably in an amount of 1:5 to 10:1 (w/w) ratio sugar:threonine, preferably 1:1 to 5:1 (w/w) ratio sugar:threonine. The ration sugar:threonine is to be understood as the (weight/weight) ratio of reducing sugar versus L-threonine thereof. The inventors have found that the addition of reducing sugar to the culture medium after the culturing step within this range of ratio provides the best results as to the generation of a typical desired herbaceous flavor profile in the following chemical thermal reaction process.

The process of the present invention comprises a step of thermally reacting the culture medium after the addition of the reducing sugar at a temperature from 75-170° C. for at least 5 minutes, preferably at least 10 minutes. This step is a chemical reaction step between different components present in the culture medium after the addition of the reducing sugar and which is thermally induced. This thermal reaction step is also commonly known as Maillard reaction. It is during this thermal reaction step that different precursor molecules from the culture medium react chemically for example with the reducing sugar, resulting in new flavor and taste active molecules. It is finally the ensemble of the selected culture medium of the present invention together with the reducing sugar that provide the full new and improved flavor profile of this natural flavor base after the thermally induced reaction step.

Preferably, the thermal reaction step of the process of the present invention is at a temperature from 85-150° C., more preferably from 95-130° C.

In a further embodiment of the present invention, the culture medium, after the addition of the reducing sugar and after the thermal reaction step, is dried to a powder. Drying can for example be achieved by spray drying or vacuum drying. Advantageously then, the obtained natural flavor base composition can be better integrated into non-liquid seasoning products such as e.g. seasoning powders or seasoning tablets.

A further aspect of the present invention is a natural flavor base obtainable by the process of the present invention. As evidence is provided below, this new natural flavor base has an improved herbaceous flavor note and is therefore distinguishable from similar prior art flavor bases. Particularly, it has been observed by the inventors that this new natural flavor base has further improved caramel and hay flavor notes as compared to respective reference flavor base products.

A still further aspect of the present invention is the use of the present natural flavor base for adding a caramel, a herbaceous and/or a hay flavored note to a food product. Preferably, the food product is selected from the group consisting of culinary soups, noodles, bouillons, sauces, seasonings, ready-to-eat meal preparations, instant and ready-to-drink beverage preparations, cookies, cakes, snacks, dough products and wafers. Preferably, the culinary soups, bouillons, sauces or seasonings products of the present invention are in the form of a powder, liquid, granulated product, tablet or paste. Furthermore, where the food product is a ready-to-eat meal preparation, a snack or a dough product, it is preferably frozen.

A still further aspect of the present invention is a method for providing a natural herbaceous, a natural caramel and/or a natural hay flavor note to a food product, comprising the step of adding the natural flavor base of the present invention into the recipe of said food product. Preferably, the method is for providing a natural herbaceous flavor note to a food or culinary seasoning product.

Those skilled in the art will understand that they can freely combine all features of the present invention disclosed herein. In particular, features described for the process for preparing the natural flavor base composition of the present invention can be combined with the flavor base obtainable by the process, the use of said flavor base and the method for use of said flavor base, and vice versa. Further, features described for different embodiments of the present invention may be combined.

Further advantages and features of the present invention are apparent from the figures and examples.

### Example 1

A cultured medium with a Corynebacterium was prepared as basically described in WO2009/040150. Thereby, a bacterial Corynebacterium glutamicum strain was grown in a culture medium comprising glucose as substrate for growth, at pH 6-7 and temperature 37° C. for about 36 hours.

Thereafter, the bacterial strain was inactivated with a heat treatment and the bacterial cells separated from the fermentation medium by filtration. The filtrate, presenting the cultured medium, was then concentrated into a powder by spray-drying.

The obtained cultured medium powder had an amino acid and natural organic acid composition as shown in Table 1. The respective amounts are provided in % w/w of total culture medium after fermentation and filtration, but before concentration.

TABLE 1
Composition based on dry matter

| Component | % w/w |
|---|---|
| Amino acids | |
| Cysteine | 0.19 |
| Tyrosine | 0.06 |
| Arginine | 0.38 |
| Alanine | 0.36 |
| Aspartic Acid | 0.05 |
| Glutamic Acid | 11.05 |
| Threonine | 0.05 |
| Organic acids | |
| Acetic acid | 1.95 |
| Lactic acid | 0.90 |
| Citric acid | 0.50 |

Technically pure L-threonine (from Sigma-Aldrich Pte Ltd, Singapore) was then added to the powdered cultured medium to achieve a total concentration of L-threonine of 40 wt % (w/w based on dry matter) of the culture medium. The powder with the L-threonine was then dissolved in water to give a 10% (w/w) solution. Thereafter, 12 wt % glucose was added to the solution, resulting in a reconstituted culture medium with added glucose having a glucose:threonine ratio of 3:1. The mixture was then subjected to a thermal heat reaction for 20 min to 120° C., and cooled thereafter to room temperature. It will be referred to as sample 1.

### Example 2

A reference sample with an equivalent amount of pure L-threonine in a buffered aqueous solution (i.e. 4 wt % solution at pH 6.5) was prepared. 12 wt % glucose was added to the L-threonine solution resulting in a glucose-threonine solution in water with a same glucose:threonine ratio of 3:1 as the culture medium mixture in Example 1. This reference sample was then subjected to the same thermal heat reaction for 20 min to 120° C. as the mixture in Example 1, and then cooled thereafter to room temperature. It will be referred to as sample 2.

### Example 3

A further reference sample was prepared where the cultured medium with the Corynebacterium glutamicum strain of Example 1 was used without the addition of L-threonine. The powdered culture medium after the spray-drying was dissolved in water to give a 10% (w/w) solution. Thereafter, 12 wt % glucose was added to the solution. The reconstituted cultured medium has a concentration of natural L-threonine of 0.006 wt %. Consequently, the culture medium with the added glucose has a glucose:threonine ratio of 12:0. The mixture was then subjected to a thermal heat reaction for 20 min to 120° C., and cooled thereafter to room temperature. It will be referred to as sample 3.

### Example 4

A further sample was prepared where the cultured medium with a Corynebacterium glutamicum naturally overproducing L-threonine was used. No additional L-threonine was added. A cultured medium comprising 4 wt % L-threonine was obtained. The culture medium was spray-dried and thereafter dissolved in water to give a 10% (w/w) solution. Thereafter, 12 wt % glucose was added to the solution. The powdered cultured medium had a concentration of natural L-threonine of 40 wt %. Consequently, the culture medium with the added glucose had a glucose:threonine ratio of 3:1. The mixture was then subjected to a thermal heat reaction for 20 min to 120° C., and cooled thereafter to room temperature. It will be referred to as sample 4.

### Example 5

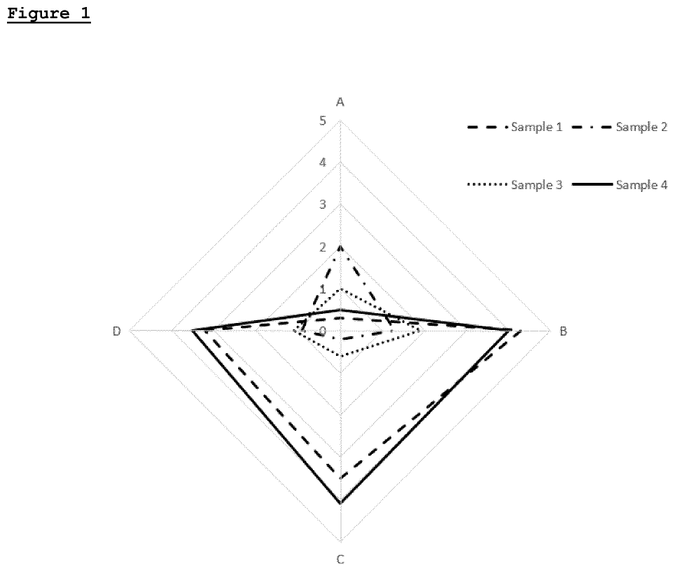

The samples 1 to 4 were subjected to a sensory evaluation by a six-member trained panel. The obtained reacted mixtures were split into 12 tasting cups. In the first tasting round the panel members were asked to come up with flavour descriptors they associate with the samples tasting them. After that the panel members agreed on four key descriptors for the samples (herbaceous, caramel, hay and malty). In a second tasting round the panel members had to judge on the strength of the perceived flavour in the samples and marking it on a scale from 1-5 (1 for very low; 2 for low; 3 for medium; 4 for high; 5 for very high). The average of all responses was calculated and is depicted in the FIG. 1.

The sensory results clearly revealed a significantly stronger flavour development for 3 descriptors, namely herbaceous, caramel and hay for the two samples 1 and 4 containing the cultured medium together with the L-threonine. The solution with an equal amount of L-threonine in water (sample 2) as well as the reference cultured medium sample without L-threonine (sample 3) were clearly inferior in flavour development as to those 3 descriptors.

Consequently and surprisingly, L-threonine in the context with a bacterial cultured broth provides a much stronger and typical top-note flavour profile when reacted with a reducing sugar, than when reacted in equal molar concentration with a same and also equal amount of a same reducing sugar in just water.

Consequently, it can be concluded from the results presented in FIG. 1 that a process comprising a culture medium comprising an elevated amount of natural L-threonine, produced and accumulated through cultivation of a bacterial strain, and thereafter thermally reacted in the presence of a reducing sugar, provides a natural flavour base which has much stronger and typical top-flavor notes related to e.g. herbaceous, caramel and/or hay flavors.

### Example 6

A culture medium from Corynebacterium sp. which has an increased amount of L-threonine can be obtained as disclosed in Thomas Hermann; Industrial production of amino acids by coryneform bacteria; Journal of Biotechnology, 104, (2003), 155-172 or as disclosed in J. Kalinowski et al.; Journal of Biotechnology, 104, (2003), 5-25. Alternatively, a culture medium comprising an increased amount of L-threonine can be obtained by culturing a Corynebacterium under the conditions as specified in U.S. Pat. No. 3,375,173.

The culture medium with accumulated free L-threonine can be further processed first for example by a heat treatment. Such a heat treatment can be for 1-5 min at a temperature of ca. 120° C.

Thereafter, the bacterial cells can be separated from the culture medium by a standard filtration step as known in the art, and further concentrated by evaporation of the water from the medium. The culture medium is then present in the form of a thick paste with a water content ranging from 20-25 wt %. The paste can then be stored at 4° C. until further processing.

The culture medium can be reconstituted again from the paste in water and glucose, as a reducing sugar, which can be added to the medium in an amount to result in a sugar:threonine ratio of for example 2:1 or 4:1. The mixture can then be reacted under thermal conditions of 125° C. for 25 min in a reaction vessel. Thereafter, the mixture is cooled down again to room temperature and dried into a powder via spray-drying, to result in a natural flavour base composition which can be used in food products.

Sensory analysis as described above in Example 5 can be conducted on this flavour base for example with a trained tasting panel. Such sensory results will reveal significant stronger flavour development for at least the 3 descriptors mentioned above if compared to reference samples with only L-threonine, sugar and water, or with using standard bacterial culture medium without the elevated accumulation of L-threonine.

1. A process for preparing a natural flavor base composition comprising the steps of:
culturing a bacterial strain in a culture medium to produce and accumulate L-threonine in the culture medium to a concentration of at least 1.0 wt % of the culture medium;
adding a reducing sugar to the culture medium after the culturing step;
thermally reacting the culture medium after the addition of the reducing sugar at a temperature from 75-170° C. for at least 5 minutes; and
wherein the reducing sugar is added to the medium in an amount of 1:5 to 12:1 (w/w) ratio sugar:threonine.

2. The process according to claim 1, wherein the bacterial strain is a genus selected from the group consisting of Corynebacterium, Arthrobacter, Brevibacterium, Bacillus and Microbacterium.

3. The process according to claim 1, wherein culturing the bacterial strain produces and accumulates L-threonine to a concentration of at least 1.5 wt % of the culture medium.

4. The process according to claim 1, further comprising a step of heat inactivation of the bacterial strain after the culturing step.

5. The process according to claim 1, wherein the separation of the bacterial strain from the culture medium is obtained by a method selected from the group consisting of sedimentation, centrifugation and filtration.

6. The process according to claim 1, wherein concentrating the culture medium after the culturing step is by partial or total evaporation of water present in the culture medium.

7. The process according to claim 1, wherein the sugar is selected from the group consisting of glucose, xylose, ribose, rhamnose, fructose, maltose, lactose, arabinose and combinations thereof.

8. The process according to claim 1, wherein the thermal reaction step is at a temperature from 85-150° C., preferably from 95-130° C.

9. The process according to claim 1, wherein the medium after the thermal reaction step is dried to a powder.

10. A natural flavor base obtainable by the process according to claim 1.

11-14. (canceled)

15. A method for providing a natural caramel, a natural herbaceous and/or a natural hay flavored flavor note to a food product comprising the step of adding a natural flavor base obtained by culturing a bacterial strain in a culture medium to produce and accumulate L-threonine in the culture medium to a concentration of at least 1.0 wt % of the culture medium, adding a reducing sugar to the culture medium after the culturing step, thermally reacting the culture medium after the addition of the reducing sugar at a temperature from 75-170° C. for at least 5 minutes, and wherein the reducing sugar is added to the medium in an amount of 1:5 to 12:1 (w/w) ratio sugar:threonine into the recipe of the food product.
